(19) United States
(12) Patent Application Publication
(10) Pub. No.: US 2019/0112548 A1
(43) Pub. Date: Apr. 18, 2019

(54) CONCENTRATED LIQUID DETERGENTS CONTAINING POLYMERS

(71) Applicant: Henkel AG & Co. KGaA, Duesseldorf (DE)

(72) Inventors: Ulrich Pegelow, Duesseldorf (DE); Sabine Schuemann, Neuss (DE); Simon Pluszynski, Duesseldorf (DE); Anna Klemmer, Duesseldorf (DE); Thorsten Bastigkeit, Wuppertal (DE)

(73) Assignee: Henkel AG & Co. KGaA, Duesseldorf (DE)

(21) Appl. No.: 16/218,643

(22) Filed: Dec. 13, 2018

Related U.S. Application Data
(63) Continuation of application No. PCT/EP2017/064517, filed on Jun. 14, 2017.

(30) Foreign Application Priority Data
Jun. 16, 2016 (DE) 10 2016 210 743.7

(51) Int. Cl. C11D 1/83; C11D 3/00; C11D 3/37

(52) U.S. Cl. CPC C11D 1/83; C11D 3/0036; C11D 11/0017; C11D 3/3757; C11D 3/3753; C11D 3/0021

(57) ABSTRACT

Highly concentrated liquid detergents with a surfactant content of 30 wt. % and more, also containing polymers in concentrations of 2 wt. % or more and displaying optimised product stability. The detergent having a specifically adapted surfactant system containing alkyl ether alkoxylates, alkyl(poly)gylcosides and additional surfactants. The invention also relates to methods for washing textiles using the described detergents and to the use thereof.

### FIELD OF THE INVENTION

The present application relates to highly concentrated liquid washing agents which have surfactant contents of 30 wt. % and more, simultaneously contain polymers in concentrations of 2 wt. % or more and demonstrate optimized product stability by comprising a specifically adapted surfactant system. The application also relates to methods for washing textiles using the described washing agents and to the use thereof.

### BACKGROUND OF THE INVENTION

Liquid washing agents are known in the prior art and have become increasingly popular with consumers in recent years since they provide a number of advantages in comparison with solid washing agents. Said advantages include, inter alia, simpler dosing, addition and dissolution in the washing liquor. In addition, they are perceived to be safer and less aggressive with respect to textiles and the environment. Since they were brought onto the market, said liquid washing agents have gained increasing popularity, in particular for washing colored textiles.

There is a general trend in the market towards highly concentrated liquid washing agents since these are associated with lower resource use, in particular owing to a lower transport weight and reduced bottle size. Moreover, such highly concentrated agents are preferred by consumers since they take up less storage space in the home.

Although agents of this kind are advantageous in respect of handling and consumer acceptance, the known agents have drawbacks in terms of their stability, in particular when being stored for a long time. These drawbacks are further compounded by the trend towards more highly concentrated products. The challenge for highly concentrated liquid washing agents consists in placing more of the required key ingredients (inter alia surfactants, polymers, enzymes, complexing agents, perfume, optical brighteners) in a lower liquid volume.

In order to achieve a washing performance that is good from the consumer's point of view, polymeric components are increasingly used in modern liquid washing agents. These are often substantially non-ionic or anionic polymers having different functionalities. Important groups are what are referred to as soil release polymers, dye transfer inhibitors (DTIs), anti-redeposition agents and polymeric dispersing agents. A particular challenge here is that of ensuring that the polymers are incorporated in a stable manner, since the compatibility of the polymeric ingredients of a liquid formulation decreases as the surfactant concentration increases. As a result, cloudiness, sedimentation or even phase separation occurs. These not only impair the aesthetic appearance of the formulation, but also have a negative impact on the washing performance.

There is therefore a need for improved highly concentrated liquid washing agent formulations which have improved properties with respect to the mentioned problems, i.e. which in particular allow large amounts of polymeric components to be incorporated in a stable manner.

### BRIEF SUMMARY OF THE INVENTION

It has now been surprisingly found that the above-mentioned disadvantages of highly concentrated liquid washing agents, i.e. washing agents having surfactant contents of 30 wt. % or more, can be overcome by a specific surfactant combination being used which allows polymeric components in amounts of 2 wt. % or more to be incorporated in a stable manner.

In a first aspect, the present invention therefore relates to liquid washing agents having a surfactant concentration of ≥30 wt. % based on the total weight of the agent, preferably in the range of from 30 to 45 wt. %, more preferably 32 to 38 wt. %, and a concentration of polymeric components of ≥2 wt. % based on the total weight of the agent, preferably 2 to 10 wt. %, more preferably 3 to 5 wt. %, characterized in that the agent contains a surfactant system which comprises non-ionic surfactants in an amount of from 5 to 20 wt. % based on the total weight of the agent, preferably 8 to 15 wt. %, the non-ionic surfactants comprising at least one alkyl ether and at least one alkyl (poly)glycoside, the weight ratio of alkyl ether to alkyl (poly)glycoside being 1:2 to 5:1, preferably 1:1 to 3:1.

In another aspect, the present invention relates to the use of a liquid washing agent according to the invention for washing textiles.

In another aspect, the present invention relates to a method for cleaning textiles, characterized in that a liquid washing agent according to the invention is used in at least one method step.

These and other aspects, features, and advantages of the invention will become apparent to a person skilled in the art through the study of the following detailed description and claims. Any feature from one aspect of the invention can be used in any other aspect of the invention. Furthermore, it will readily be understood that the examples contained herein are intended to describe and illustrate but not to limit the invention and that, in particular, the invention is not limited to these examples. Unless indicated otherwise, all percentages indicated are percent by weight based on the total weight of the agent or composition. Numerical ranges that are indicated in the format “from x to y” include the cited values. If several preferred numerical ranges are indicated in this format, it is self-evident that all ranges that result from the combination of the various endpoints are also included.

### DETAILED DESCRIPTION OF THE INVENTION

“At least one”, as used herein, refers to 1, 2, 3, 4, 5, 6, 7, 8, 9 or more. In connection with components of the compositions described herein, this information does not refer to the absolute amount of molecules, but to the type of the component. “At least one anionic surfactant” therefore signifies, for example, one or more different anionic surfactants, which is to say one or more different types of anionic surfactants. Together with stated amounts, the stated amounts refer to the total amount of the correspondingly designated type of component.

“Roughly”, “approximately” or “about”, as used herein in reference to a numerical value, refer to the corresponding numerical value±10%, preferably±5%.

The washing agents described herein may be washing agents for textiles or natural fibers. In the context of the invention, the washing agents also include auxiliary washing agents, which are added to the actual washing agent when washing textiles manually or using a machine in order to achieve an additional effect or in order to reinforce an effect. Furthermore, within the scope of the invention, washing agents also include textile pre-treatment and post-treatment agents, i.e. agents with which the piece of laundry comes into contact before it is actually washed, for example in order to loosen stubborn dirt, and also agents which impart other desirable properties to the laundry, for example softness to touch, crease resistance or low static charge, in a step that comes after the actual textile washing process. The agents mentioned last include, inter alia, softeners. In preferred embodiments, however, the agent is a textile washing agent.

In various embodiments of the invention, the liquid washing agents have a total surfactant content of from 30 to 45 wt. %, preferably32 to 38 wt. %, of which 5 to 20 wt. %, preferably 8 to 15 wt. % are non-ionic surfactants and the remainder are anionic, cationic, zwitterionic and/or amphoteric surfactants, but preferably anionic surfactants.

The non-ionic surfactants comprise at least one alkyl ether. In a preferred embodiment of the invention, the agents described herein contain, as the non-ionic surfactant, at least one fatty alcohol alkoxylate having the following formula:

R¹—O-(AO)ₘ—H,

where R¹ is a linear or branched alkyl functional group, AO is an ethylene oxide (EO) or propylene oxide (PO) group and m is an integer from 1 to 50. In the above formula, R¹ represents a linear or branched, substituted or unsubstituted alkyl functional group. In a preferred embodiment of the present invention, R¹ is a linear or branched, preferably unsubstituted, alkyl functional group having 5 to 30 carbon atoms, preferably having 7 to 25 carbon atoms and in particular having 10 to 19 carbon atoms. Preferred R¹ functional groups are selected from decyl, undecyl, dodecyl, tridecyl, tetradecyl, pentadecyl, hexadecyl, heptadecyl, octadecyl, nonadecyl functional groups and mixtures thereof, the representatives having an even number of carbon atoms being preferred. Particularly preferred R¹ functional groups are derived from fatty alcohols having 12 to 19 carbon atoms, for example from coconut fatty alcohol, tallow fatty alcohol, lauryl, myristyl, cetyl or stearyl alcohol or oxo alcohols having 10 to 19 carbon atoms.

AO is an ethylene oxide (EO) or propylene oxide (PO) group, preferably an ethylene oxide group. The index m is an integer from 1 to 50, preferably 2 to 20, and more preferably 2 to 10. In particular, m is 3, 4, 5, 6 or 7. The agent according to the invention may contain mixtures of non-ionic surfactants which have different degrees of ethoxylation.

In summary, particularly preferred fatty alcohol alkoxylates are those of formula:

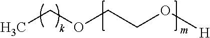

where k=9 to 17 and m=3, 4, 5, 6 or 7. More particularly preferred representatives are fatty alcohols having 10 to 18 carbon atoms and 7 EO (k=11 to 17 and m=7).

Fatty alcohol ethoxylates of this kind are available under the commercial names Dehydol® LT7 (Cognis), Lutensol® AO7 (BASF), Lutensol® M7 (BASF) and Neodol® 45-7 (Shell Chemicals).

In addition, the liquid washing agent contains, as the non-ionic surfactant, at least one alkyl (poly)glycoside of formula:

R²O-[G]ₚ,

in which R² represents a linear or branched alkyl having 8 to 26, preferably 8 to 20, more preferably 8 to 18, 8 to 10 or 12 to 16 carbon atoms, G represents a sugar residue having 5 or 6 carbon atoms and p represents numbers from 1 to 10. G can represent sugar having 5 (pentoses) or 6 (hexoses) carbon atoms, in particular glucose, and the degree of oligomerization p can be from 1 to 10.

Particularly preferred alkyl (poly)glycosides are derived from glucose and can be described by the formula:

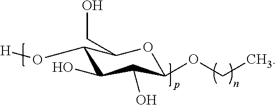

in which n represents 7 to 15, in particular 7 to 9 or 11 to 15 and p represents numbers from 1 to 10.

The degree of oligomerization p in the above-mentioned formulae is preferably <8, more preferably <6, even more preferably <4 and in particular <2. Particularly preferred surfactant mixtures or washing or cleaning agents according to the invention contain non-ionic surfactants in which p represents numbers from 1.4 to 1.8.

These fractional degrees of oligomerization are achieved by mixtures which contain varying amounts of surfactants of the above formulae, in which p represents an integer, preferably 1, 2, 3 or 4, for the single molecule.

In summary, washing agents that are preferred according to the invention are characterized in that they contain C₈₋₁₆, in particular C₈₋₁₀ or C₁₂₋₁₆ alkyl oligo(1,4)glucoside. Suitable alkyl (poly)glycosides are available for example under the trade names Plantacare® or Plantaren® from BASF (BASF SE, DE) and include, inter alia, Plantacare® 220 UP (APG 220 UP) and Plantaren® 1200 UP NP (APG 600 UP).

The agents of the invention contain the alkyl ethers, in particular the above-described fatty alcohol alkoxylates and alkyl polyol glycosides in weight ratios of from 1:2 to 5:1, preferably 1:1 to 3:1. In this case, the amount of alkyl ether or fatty alcohol alkoxylate can be, for example, from 5 to 15 wt. %, preferably 6 to 10 wt. % and/or the amount of alkyl (poly)glycoside can be, for example, from 2 to 8 wt. %, preferably 3 to 5 wt. %, in each case based on the total weight of the composition.

In various embodiments, the liquid washing agent does not contain any additional non-ionic surfactants apart from these two mentioned types of non-ionic surfactants.

Alternatively, however, the washing agent can contain additional non-ionic surfactants provided that the total content of non-ionic surfactants in the agent does not exceed 20 wt. %.

Amine oxides may be contained as additional non-ionic surfactants, for example. In principle, all the amine oxides found in the prior art for this purpose, i.e. compounds that have the formula R¹R²R³NO, in which each of R¹, R² and R³, independently of one another, is an optionally substituted hydrocarbon chain having 1 to 30 carbon atoms, can be used as the amine oxide. Amine oxides that are particularly preferably used are those in which R¹ is alkyl having 12 to 18 carbon atoms and R² and R³ are each independently alkyl having 1 to 4 carbon atoms, in particular alkyl dimethyl amine oxides having 12 to 18 carbon atoms. Examples of representatives of suitable amine oxides are N-coconut alkyl-N,N-dimethyl amine oxide, N-tallow alkyl-N,N-dihydroxyethyl amine oxide, myristyl/cetyl dimethyl amine oxide or lauryl dimethyl amine oxide.

Further non-ionic surfactants which can be used may be, for example:
polyol fatty acid esters;
alkoxylated triglycerides;
alkoxylated fatty acid alkyl esters of formula R³CO—(OCH₂CHR⁴)_{w}OR⁵, in which R³CO represents a linear or branched, saturated and/or unsaturated acyl functional group having 6 to 22 carbon atoms, R⁴ represents hydrogen or methyl, R⁵ represents linear or branched alkyl groups having 1 to 4 carbon atoms, and w is 1 to 20;
hydroxy mixed ethers;
sorbitan fatty acid esters and addition products of ethylene oxide to sorbitan fatty acid esters such as the polysorbates;
sugar fatty acid esters and addition products of ethylene oxide to sugar fatty acid esters;
addition products of ethylene oxide to fatty acid alkanolamides and fatty amines; and
fatty acid-N-alkyl glucamides.

The agents described herein may also contain a plurality of the above-described non-ionic surfactants.

The remaining surfactant content is preferably made up of anionic surfactants. In various embodiments, the agents therefore do not contain any cationic surfactants and preferably also do not contain any amphoteric or zwitterionic surfactants.

As the anionic surfactants, in particular those of the sulfonate type are used, preferably alkylbenzene sulfonates, olefin sulfonates, i.e. mixtures of alkene and hydroxyalkane sulfonates, and disulfonates, as are obtained, for example, from monoolefins having 12 to 18 carbon atoms and a terminal or an internal double bond by way of sulfonation with gaseous sulfur trioxide and subsequent alkaline or acid hydrolysis of the sulfonation products. Alkane sulfonates having 12 to 18 carbon atoms and the esters of a-sulfofatty acids (ester sulfonates), for example the a-sulfonated methyl esters of the hydrogenated coconut, palm kernel or tallow fatty acids, are also suitable.

Alkylbenzene sulfonates are preferably selected from linear or branched alkylbenzene sulfonates of formula:

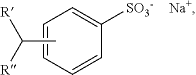

in which R′ and R″, independently, are H or alkyl, and together contain 9 to 19, preferably 9 to 15, and in particular 9 to 13, carbon atoms. A more particularly preferred representative is sodium dodecylbenzenesulfonate.

The salts of the sulfuric acid half-esters of fatty alcohols having 12 to 18 carbon atoms, for example from coconut fatty alcohol, tallow fatty alcohol, lauryl, myristyl, cetyl or stearyl, or of oxo alcohols having 10 to 20 carbon atoms and the half-esters of secondary alcohols having this chain length are preferred as alk(en)yl sulfates. From a washing perspective, the alkyl sulfates having 12 to 16 carbon atoms and alkyl sulfates having 12 to 15 carbon atoms as well as alkyl sulfates having 14 and 15 carbon atoms are preferred. 2,3 alkyl sulfates are also suitable anionic surfactants.

The secondary alkane sulfonates are also particularly suitable. “Secondary”, as used herein, refers to the generally known chemical meaning of this term and indicates that the carbon atom to which the sulfonate group is covalently bonded additionally has two covalent bonds to two organic (alkylic) functional groups, i.e. carbon atoms, and one covalent bond to a hydrogen atom. Together with the carbon atom to which they are bonded, the two organic (alkylic) functional groups form a linear or branched alkyl having 1 to 50 carbon atoms. In order to balance out the negative charge of the sulfonate group, the alkane sulfonate according to the invention further comprises any cation, preferably selected from the group comprising Na⁻, K⁺, NH₄⁺, ½ Zn²⁺, ½ Mg²⁺, ½ Ca²⁺, ½ Mn²⁺ and mixtures thereof, particularly preferably Na⁺.

In various embodiments of the invention, secondary alkane sulfonate is one of formula:

R¹CH(SO₃⁻X⁴)R²,

where R¹ and R² are each independently a linear or branched alkyl having 1 to 20 carbon atoms and form, together with the carbon atom to which they are bonded, a linear or branched alkyl, preferably having 10 to 30 carbon atoms, preferably having 10 to 20 carbon atoms and X⁺ is selected from the group comprising Na⁺, K⁺, NH₄⁺, ½Zn²⁺, ½ Mg²⁺, ½ Ca²⁺, ½ Mn²⁻ and mixtures thereof, preferably Na⁺. Particularly preferred are secondary alkane sulfonates of formula:

H₃C−(CH₂)_{N}—CH(SO₃⁻X⁺)—(CH₂)_{M}—CH₃,

where m and n are, independently of each other, an integer between 0 and 15. Preferably, m and n are, independently of each other, an integer between 7 and 15 and more preferably between 11 and 14. X⁺ is further selected from the group comprising Na⁺, K⁺, NH₄⁺, ½ Zn²⁺, ½ Mg²⁺, ½ Ca²⁺, ½ Mn²⁺ and mixtures thereof, preferably Na⁻.

Additional suitable anionic surfactants are those of the sulfate type and in this case in particular the alkyl ether sulfates.

Preferred alkyl ether sulfates are those of the following formula:

R⁴—O-(AO)ₙ—SO₃⁻X⁺,

where R⁴ is a linear or branched alkyl having 5 to 30 carbon atoms, preferably having 7 to 25 carbon atoms and more preferably having 10 to 19 carbon atoms. Moreover, in the above formula, AO represents an ethylene oxide (EO) or propylene oxide (PO) group, preferably an ethylene oxide (EO) group and n represents an integer from 1 to 50, preferably from 1 to 20 and more preferably from 2 to 10. X⁺ is any cation and is preferably selected from the group comprising Na⁺, K⁺, NH₄⁺, ½ Zn²⁺, ½ Mg²⁺, ½ Ca²⁺, ½ Mn²⁺ and mixtures thereof, particularly preferably Na⁺.

In the above formula, R⁴ represents a linear or branched, substituted or unsubstituted alkyl functional group. In a preferred embodiment of the present invention, R⁴ is a linear or branched, preferably unsubstituted, alkyl functional group having 5 to 30 carbon atoms, preferably having 7 to 25 carbon atoms and in particular having 10 to 19 carbon atoms. Preferred R⁴ functional groups are selected from decyl, undecyl, dodecyl, tridecyl, tetradecyl, pentadecyl, hexadecyl, heptadecyl, octadecyl, nonadecyl functional groups and mixtures thereof, the representatives having an even number of carbon atoms being preferred. Particularly preferred R⁴ functional groups are derived from fatty alcohols having 12 to 19 carbon atoms, for example from coconut fatty alcohol, tallow fatty alcohol, lauryl, myristyl, cetyl or stearyl alcohol or from oxo alcohols having 10 to 19 carbon atoms.

AO is an ethylene oxide (EO) or propylene oxide (PO) group, preferably an ethylene oxide group. The index m is an integer from 1 to 50, preferably 2 to 20, and more preferably 2 to 10. In particular, m is 3, 4, 5, 6 or 7. The agent according to the invention may contain mixtures of non-ionic surfactants which have different degrees of ethoxylation.

The alkyl ether sulfate is preferably one of formula:

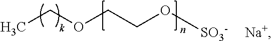

where k=11 to 19, n=2, 3, 4, 5, 6, 7 or 8. Very particularly preferred representatives are Na fatty alcohol ether sulfates having 12 to 18 carbon atoms and 2 EO (k=11 to 13 and n=2). The given degree of ethoxylation represents a statistical average that can correspond to an integer or a fractional number for a specific product. The given degrees of alkoxylation generally represent statistical averages that can correspond to an integer or a fractional number for a specific product. Preferred alkoxylates/ethoxylates have a narrowed homolog distribution (narrow range ethoxylates, NRE).

The above-described surfactants are used in customary amounts, the amount being selected such that the total surfactant content of the agent according to the invention, as described above, is ≥30 wt. %, typically up to 45 wt. %. Preferred surfactant amounts are in the range of from 32 to 38 wt. %. In preferred embodiments, the agents contain at least one, preferably at least two anionic surfactants and at least two non-ionic surfactants, as defined above. The anionic surfactants are preferably alkylbenzene sulfonates, as described above, which are typically contained in the agents in amounts of from 10 to 25 wt. %, preferably 12 to 20 wt. %, particularly preferably 14 to 18 wt. %. Additionally or alternatively, the agents may also contain alkyl ether sulfates, typically in amounts of from 2 to 10 wt. %, in particular 3 to 8 wt. %. The total content of anionic surfactants is typically from 15 to 25 wt. %. In addition to the anionic surfactants, non-ionic surfactants are contained in amounts of from 5 to 20 wt. %, preferably 8 to 15 wt. %. The non-ionic surfactants comprise at least one alkyl ether, preferably fatty alcohol alkoxylate, as described above, typically in amounts of from 5 to 15 wt. %, preferably 6 to 10 wt. %, and at least one alkyl (poly)glycoside, as described above, typically in amounts of from 2 to 8 wt. %, preferably 3 to 5 wt. %. In particularly preferred embodiments, the liquid washing agents therefore contain from 12 to 20, preferably 14 to 18 wt. % of alkylbenzene sulfonates, 2 to 10, preferably 3 to 8 wt. % of alkyl ether sulfates, 5 to 15, preferably 6 to 10 wt. % of alkyl ether, in particular fatty alcohol alkoxylates, and 2 to 8, preferably 3 to 5 wt. % of alkyl (poly)glycosides.

In addition, the washing agent can contain at least one fatty acid soap. Said soaps are advantageous in particular for cold washing performance. Preferred washing agents are therefore characterized in that they contain, based on the weight thereof, 0.1 to 15 wt. %, preferably 0.2 to 12.5 wt. %, more preferably 0.5 to 3 wt. % of soaps. Soaps of fatty acids having 12 to 18 carbon atoms are particularly preferred. The fatty acid soaps can be present in the form of the sodium, potassium, magnesium or ammonium salts thereof. Said soaps are preferably present in the form of the sodium salts and/or ammonium salts thereof.

The liquid washing agents described herein additionally contain 2 or more wt. %, based on the total weight of the agent, preferably from 2 to 10 wt. %, more preferably 3 to 5 wt. % of polymeric components, in particular soil release polymers (SRPs), anti-redeposition agents, dye transfer inhibitors (DTIs), polymeric dispersing agents and combinations of the above.

In particular oligoesters preferably obtainable from terephthalic acid, isophthalic acid, sulfoisophthalic acid and/or the methyl esters thereof, aliphatic dicarboxylic acids (saturated and/or unsaturated), for example adipic acid, and/or the anhydrides thereof, aliphatic substituted dicarboxylic acids, for example nonyl-succinic acid, alkylene glycoles (ethylene glycol, 1,2-propylene glycol, 1,2-butylene glycol), polyethylene glycols, alkyl polyethylene glycols, polyethylene glycol benzoic acid esters, polyethylene glycol sulfobenzoic acid esters and optionally alkanol amines can be used as SRPs. Terephthalate-PEG-based polymers, as are commercially available under the trade name Texcare®, for example, are preferred. Alternatively, (co)polymers based on polyethylene imine, polyvinyl acetate and polyethylene glycol may also be used.

Suitable polymers which allow the removal of dirt are generally already sufficiently known from the prior art. Polymers which are known for this purpose in the prior art can therefore be used in particular.

In order to effectively prevent dye from dissolving or transferring to other textiles during washing and/or cleaning of dyed textiles, the composition according to the invention may contain a dye transfer inhibitor. It is preferable for the dye transfer inhibitor to be a polymer or a copolymer of cyclic amines such as vinylpyrrolidone and/or vinylimidazole.

Suitable polymers include polyvinylpyrrolidone (PVP), polyvinylimidazole (PVI), copolymers of vinylpyrrolidone and vinylimidazole (PVP/PVI), polyvinylpyridine-N-oxide, poly-N-carboxymethyl-4-vinylpyridium chloride and mixtures thereof. Polyvinylpyrrolidone (PVP), polyvinylimidazole (PVI) or copolymers of vinylpyrrolidone and vinylimidazole (PVP/PVI) are particularly preferably used as a dye transfer inhibitor.

In particular polycarboxylates can be used as anti-redeposition agents. Suitable materials can be obtained by the polymerization or copolymerization of unsaturated carboxylic acid monomers, for example acrylic acid, maleic acid (or maleic anhydride), fumaric acid, itaconic acid, aconitic acid, mesaconic acid, citraconic acid and methylmalonic acid. Particularly preferred are acrylate polymers and acrylic acid/maleic acid copolymers.

Suitable SRPs, anti-redeposition agents and DTIs are also described, for example, in the international patent publication WO 2009/153184 A1 on pages 25-39 under the headings “Dye transfer inhibitors”, “Anti-redeposition agents” and “Soil release polymers”. The disclosure of said document in respect of the mentioned polymers is included in its entirety in the present application by way of reference.

In various embodiments of the invention, the polymers contained in the agents comprise at least one SRP and optionally at least one DTI.

The liquid washing agents described herein additionally contain preferably at least one enzyme. The at least one enzyme can be any enzyme which is known in the prior art, can initiate a catalytic activity in a washing or cleaning agent and includes, without being limited thereto, proteases, amylases, lipases, cellulases, hemicellulases, mannanases, pectin-cleaving enzymes, tannanases, xylanases, xanthanases, ß-glucosidases, carrageenases, perhydrolases, oxidases, oxidoreductases and mixtures thereof, for example. In a preferred embodiment, the at least one enzyme is selected from the group consisting of proteases, amylases, lipases, cellulases and mixtures thereof. In principle, these enzymes are of natural origin; starting from the natural molecules, however, improved variants are available for use in washing or cleaning agents, which variants are correspondingly preferably used.

Among the proteases, the subtilisin-type proteases are preferred. Examples of these are subtilisins BPN′ and Carlsberg, protease PB92, subtilisins 147 and 309, the alkaline protease from Bacillus lentus, subtilisin DY, and the enzymes thermitase, proteinase K and the proteases TW3 and TW7, which belong to the subtilases but no longer to the subtilisins in the narrower sense. Subtilisin Carlsberg is available in a developed form under the trade name Alcalase® from the company Novozymes A/S, Bagsvaerd, Denmark. Subtilisins 147 and 309 are sold under the trade names Esperase® and Savinase®, respectively, from the company Novozymes.

The protease variants referred to by the name BLAP® are derived from the proteases from Bacillus lentus DSM 5483. Other suitable proteases are, for example, the enzymes available under the trade names Durazym®, Relase®, Everlase®, Nafizym®, Natalase®, Kannase® and Ovozyme® from the company Novozymes, the enzymes available under the trade names Purafect®, Purafect® OxP, Purafect® Prime, Excellase® and Properase® from the company Genencor, the enzyme available under the trade name Protosol® from the company Advanced Biochemicals Ltd., Thane, India, the enzyme available under the trade name Wuxi® from the company Wuxi Snyder Bioproducts Ltd., China, the enzymes available under the trade names Proleather® and Protease P® from the company Amano Pharmaceuticals Ltd., Nagoya, Japan, and the enzyme available under the name Proteinase K-16 from the company Kao Corp., Tokyo, Japan. The proteases from Bacillus gibsonii and Bacillus pumilus are also particularly preferably used.

Examples of amylases are the α-amylases from Bacillus licheniformis, from B. amyloliquefaciens or from B. stearothermophilus, as well as the developments thereof that have been improved for use in cleaning agents. The enzyme from B. licheniformis is available from the company Novozymes under the name Termamyl® and from the company Genecor under the name Purastar® ST. Development products of said α-amylase are available from the company Novozymes under the trade names Duramyl® and Termamyl® ultra, from the company Genencor under the name Purastar® OxAm and from the company Daiwa Seiko Inc., Tokyo, Japan, as Keistase®. The α-amylase from B. amyloliquefaciens is sold by the company Novozymes under the name BAN®, and derived variants of the α-amylase from B. stearothermophilus are sold under the names SG® and Novamyl®, likewise by the company Novozymes. Others that are particularly noteworthy for this purpose are the α-amylase from Bacillus sp. A 7-7 (DSM 12368) and cyclodextrin glucanotransferase (CGTase) from B. agaradherens (DSM 9948). Fusion products of all the mentioned molecules can also be used. In addition, the developments of the α-amylase from Aspergillus niger and A. oryzae which are available under the trade name Fungamyl® from the company Novozymes are suitable. Additional trade products which can be advantageously used are, for example, Amylase-LT® and Stainzyme® or Stainzyme ultra® or Stainzyme plus®, the latter likewise from the company Novozymes. Variants of said enzymes which can be obtained by point mutations can also be used according to the invention.

Examples of lipases or cutinases which can be used, in particular due to their triglyceride-cleaving activities, but also in order to produce peracids in situ from suitable precursors, are the lipases which can be originally obtained or are developed from Humicola lanuginosa (Thermomyces lanuginosus), in particular those with the amino acid substitution D96L. They are sold, for example, by the company Novozymes under the trade names Lipolase®, Lipolase® Ultra, LipoPrime®, Lipozyme® and Lipex®. In addition, the cutinases which have originally been isolated from Fusarium solani pisi and Humicola insolens can be used. Lipases which are likewise suitable are available from the company Amano under the names Lipase CE®, Lipase P®, Lipase B®, or Lipase CES®, Lipase AKG®, Bacillus sp. Lipase®, Lipase AP®, Lipase M-AP® and Lipase AML®. From the company Genencor, the lipases or cutinases whose starting enzymes have originally been isolated from Pseudomonas mendocina and Fusarium solanii can be used, for example. The preparations M1 Lipase® and Lipomax® originally sold by the company Gist-Brocades, the enzymes sold by the company Meito Sangyo KK, Japan, under the names Lipase MY-30®, Lipase OF® and Lipase PL®, and also the product Lumafast® from the company Genencor, should be mentioned as additional significant trade products.

Depending on the purpose, cellulases can be present as pure enzymes, as enzyme preparations or in the form of mixtures in which the individual components are advantageously complementary in terms of their different performance aspects. These performance aspects include in particular the contributions of the cellulases to the primary washing performance of the agent (cleaning performance), to the secondary washing performance of the agent (anti-redeposition effect or graying inhibitor), to the softening (textile effect) or to the application of a “stone-washed” effect. A suitable fungal, endoglucanase (EG)-rich cellulase preparation, or the developments thereof, is provided by the company Novozymes under the trade name Celluzyme®. The products Endoase® and Carezyme®, likewise available from the company Novozymes, are based on the 50 kD-EG or the 43 kD-EG from H. insolens DSM 1800. Other trade products from this company which can be used are Cellusoft®, Renozyme® and Celluclean®. The 20 kD-EG from Melanocarpus, which are available from the company AB Enzymes, Finland, under the trade names Ecostone® and Biotouch®, can also be used, for example. Other trade products from the company AB Enzymes are Econase® and Ecopulp®. Other suitable cellulases are from Bacillus sp. CBS 670.93 and CBS 669.93, those from Bacillus sp. CBS 670.93 being available from the company Genencor under the trade name Puradax®. Other trade products from the company Genencor are “Genencor detergent cellulase L” and IndiAge® Neutra. Variants of said enzymes which can be obtained by point mutations can also be used according to the invention. Particularly preferred cellulases are Thielavia terrestris Cellulasevarianten, cellulases from Melanocarpus, in particular Melanocarpus albomyces, EGIII-type cellulases from Trichoderma reesei or variants obtained therefrom.

Moreover, other enzymes, which can be grouped together under the term “hemicellulases”, can be used in particular in order to remove certain problematic stains. These enzymes include mannanases, xanthanlyases, xanthanases, xyloglucanases, xylanases, pullulanases, pectin-cleaving enzymes and ß-glucanases, for example. The ß-glucanase obtained from Bacillus subtilis is available from the company Novozymes under the name Cereflo®. Particularly preferred hemicellulases according to the invention are mannanases, which are sold under the trade names Mannaway® from the company Novozymes or Purabrite® from the company Genencor, for example. In the context of the present invention, the pectin-cleaving enzymes include enzymes with the names pectinase, pectatlyase, pectinesterase, pectindemethoxylase, pectinmethoxylase, pectinmethylesterase, pectase, pectinmethylesterase, pectinoesterase, pectin pectylhydrolase, pectindepolymerase, endopolygalacturonase, pectolase, pectinhydrolase, pectin polygalacturonase, endopolygalacturonase, poly-α-1,4-galacturonide glycanohydrolase, endogalacturonase, endo-D-galacturonase, galacturan 1,4-α-galacturonidase, exopolygalacturonase, poly(galacturonate) hydrolase, exo-D-galacturonase, exo-D-galacturonanase, exopoly-D-galacturonase, exo-poly-α-galacturonosidase, exopolygalacturonosidase or exopolygalacturanosidase. Examples of enzymes which are suitable in this respect are available, for example, under the names Gamanase®, PektinexAR®, X-Pect® or Pectaway® from the company Novozymes, under the names Rohapect UF®, Rohapect TPL®, Rohapect PTE100®, Rohapect MPE®, Rohapect MA plus HC, Rohapect DA12L®, Rohapect 10L® or Rohapect B1L® from the company AB Enzymes and under the name Pyrolase® from the company Diversa Corp., San Diego, Calif., USA.

From all these enzymes, those which are comparatively stable with respect to oxidation or have been stabilized by point mutagenesis, for example, are particularly preferred. In particular the trade products Everlase® and Purafect® OxP should be mentioned as examples of such proteases and Duramyl® should be mentioned as an example of such an α-amylase.

In order to increase the bleaching effect, oxidoreductases, for example oxidases, oxygenases, catalases (which react as peroxidases at low H₂O₂ concentrations), peroxidases such as haloperoxidases, chloroperoxidases, bromoperoxidases, lignin peroxidases, glucose peroxidases, or mangan peroxidases, dioxygenases or laccases (phenoloxidases, polyphenoloxidases) can also be contained in the washing agents, in particular liquid washing agents. Denilite® 1 and 2 from the company Novozymes should be mentioned as suitable trade products.

The liquid washing agents contain the at least one enzyme in total amounts established in the prior art. The at least one enzyme can thus be contained in a total amount of from 1×10⁻⁸ to 5 wt. % based on the active protein or also in a total amount of from 0.001 to 3 wt. %, or 0.01 to 1.5 wt. % or 0.05 to 1.25 wt. %. The amounts stated should be understood to mean that each enzyme contained can be contained in the mentioned amounts. The enzymes are preferably used as liquid enzyme formulation(s).

The at least one enzyme, which is present in a washing or cleaning agent, facilitates the cleaning performance of the agent on certain stains or spots. An agent according to the invention particularly preferably contains a plurality of enzymes, it being possible for the enzymes to belong to the same or different enzyme classes. The enzymes particularly preferably have synergistic effects with respect to the action thereof against particular stains or marks, i.e. the enzymes contained in the composition assist one another in terms of the cleaning performance thereof.

In addition, the washing agent may contain additional ingredients which further improve the practical and/or aesthetic properties of the washing agent. In the context of the present invention, the washing agent preferably additionally contains one or more substances from the group of builders/complexing agents, bleaching agents, electrolytes, perfumes, perfume carriers, fluorescing agents, dyes, hydrotropic substances, suds suppressors, silicone oils, graying inhibitors, anti-shrink agents, crease protection agents, antimicrobial active ingredients, germicides, fungicides, antioxidants, preservatives, corrosion inhibitors, antistatic agents, bittering agents, ironing aids, repellents and impregnating agents, swelling agents and non-slip agents, softening components, pH adjusters and UV absorbers.

All substances which destroy or absorb dyes by means of oxidation, reduction or adsorption, and thus decolorize materials, can be used as bleaching agents. These include, inter alia, hypohalite-containing bleaching agents, hydrogen peroxide, perborate, percarbonate, peracetic acid, diperoxyazelaic acid, diperoxy dodecanedioic acid and oxidative enzyme systems. However, liquid washing agents are typically free of non-enzymatic bleaching agents.

In particular silicates, aluminum silicates (in particular zeolites), carbonates, phosphonates, organic di- and polycarboxylic acids or salts thereof and mixtures of these substances should be mentioned as builders which can be contained in the washing agent.

Organic builders which may be present in the washing agent are, for example, the polycarboxylic acids that can be used in the form of the sodium salts thereof, polycarboxylic acids being understood to mean those carboxylic acids that carry more than one acid function. For example, these are citric acid, adipic acid, succinic acid, glutaric acid, malic acid, tartaric acid, maleic acid, fumaric acid, saccharic acids, aminocarboxylic acids, and mixtures thereof. Preferred salts are the salts of polycarboxylic acids such as citric acid, adipic acid, succinic acid, glutaric acid, tartaric acid, saccharic acids, and mixtures thereof. Aminocarboxylic acids such as in particular glutaminediacetic acid (GLDA) and methylglycine diacetic acid (MGDA) are likewise suitable and preferred.

Polymeric polycarboxylates are also suitable as builders. These include the alkali metal salts of polyacrylic acid or of polymethacrylic acid, for example those having a relative molecular mass of from 600 to 750,000 g/mol.

Suitable polymers are in particular polyacrylates which preferably have a molecular mass of from 1,000 to 15,000 g/mol. From this group, the short-chain polyacrylates which have molar masses of from 1,000 to 10,000 g/mol and particularly preferably 1,000 to 5,000 g/mol can in turn be preferred owing to their superior solubility.

In addition, copolymeric polycarboxylates are suitable, in particular those of acrylic acid with methacrylic acid and of acrylic acid or methacrylic acid with maleic acid. In order to improve the water solubility, the polymers may also contain allyl sulfonic acids, such as allyl oxybenzene sulfonic acid and methallyl sulfonic acid, as monomers.

In liquid washing agents, preferred soluble builders, for example citric acid, or acrylic polymers having a molar mass of from 1,000 to 5,000 g/mol, are used.

The washing agents can additionally contain phosphonates, for example HEDP (1-hydroxyethane-1,1-diphosphonic acid) or DTPMP (diethylenetriamine penta(methylene phosphonate), as builders and complexing agents.

Preferred liquid washing agents preferably contain water as the main solvent. In this case, it is preferable for the washing agent to contain more than 5 wt. %, preferably more than 15 wt. % and particularly preferably more than 25 wt. % of water, in each case based on the total amount of washing agent. Particularly preferred liquid washing agents contain, based on the weight thereof, from 5 to 65 wt. %, preferably 10 to 60 wt. %, particularly preferably 25 to 55 wt. %, and in particular 30 to 50 wt. % of water. Alternatively, the liquid washing agents may be low-water to water-free washing agents, the water content in a preferred embodiment being less than 10 wt. % and more preferably less than 8 wt. %, in each case based on the total liquid washing agent.

In addition, non-aqueous solvents can be added to the washing agent. Suitable non-aqueous solvents include monovalent or polyvalent alcohols, alkanol amines or glycol ethers, provided they are miscible with water in the stated concentration range. The solvents are preferably selected from ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol mono methyl ether, dipropylene glycol mono ethyl ether, methoxytriglycol, ethoxytriglycol, butoxytriglycol, 1-butoxylethoxy-2-propanol, 3 -methyl-3-methoxybutanol, propylene-glycol-t-butyl ether, di-n-octylether and mixtures of these solvents. 1,2-propanediol and glycerol are particularly preferred. It is preferable for the washing agent to contain an alcohol of this kind, in particular 1,2-propanediol and/or glycerol, in amounts of between 0.5 and 15 wt. %, based on the total washing agent.

The washing agents described herein, in particular the described low-water to water-free liquid washing agents, can be filled into a water-soluble wrapping and thus be a component of a water-soluble packaging. If the washing agent is packaged in a water-soluble wrapping, it is preferable for the water content to be less than 10 wt. %, based on the total agent.

In addition to the washing agent, a water-soluble packaging contains a water-soluble wrapping. The water-soluble wrapping is preferably formed by a water-soluble film material.

Water-soluble packaging of this kind can be produced either by a vertical form fill seal (VFFS) method or by a thermoforming method.

The thermoforming method generally includes forming a first layer of a water-soluble film material in order to form convex portions for receiving a composition therein, filling the composition into the convex portions, covering the convex portions filled with the composition with a second layer of a water-soluble film material and sealing the first and second layers together at least around the convex portions.

The water-soluble wrapping is preferably formed of a water-soluble film material selected from the group consisting of polymers or polymer blends. The wrapping can be formed of one or of two or more layers of the water-soluble film material. The water-soluble film material of the first layer and of the additional layers, if present, can be the same or different.

The water-soluble packaging, comprising the washing agent and the water-soluble wrapping, can comprise one or more compartments. The liquid washing agent can be contained in one or more compartments, if present, of the water-soluble wrapping. The amount of liquid washing agent preferably corresponds to the full or half dose required for a wash cycle.

It is preferable for the water-soluble wrapping to contain polyvinyl alcohol or a polyvinyl alcohol copolymer.

Suitable water-soluble films for producing the water-soluble wrapping are preferably based on a polyvinyl alcohol or a polyvinyl alcohol copolymer of which the molecular weight is in the range of from 10,000 to 1,000,000 g/mol, preferably 20,000 to 500,000 g/mol, particularly preferably 30,000 to 100,000 g/mol and in particular 40,000 to 80,000 g/mol.

Polymers selected from the group comprising acrylic acid-containing polymers, polyacrylamides, oxazoline polymers, polystyrene sulfonates, polyurethanes, polyesters, polyether polylactic acid, and/or mixtures of the above polymers, can additionally be added to a film material suitable for producing the water-soluble wrapping.

In addition to vinyl alcohol, preferred polyvinyl alcohol copolymers comprise dicarboxylic acids as additional monomers. Suitable dicarboxylic acids are itaconic acid, malonic acid, succinic acid and mixtures thereof, itaconic acid being preferred.

In addition to vinyl alcohol, likewise preferred polyvinyl alcohol copolymers comprise an ethylenically unsaturated carboxylic acid, the salt thereof or the ester thereof. In addition to vinyl alcohol, polyvinyl alcohol copolymers of this kind particularly preferably contain acrylic acid, methacrylic acid, acrylic acid ester, methacrylic acid ester or mixtures thereof.

Suitable water-soluble films for use in the wrappings of the water-soluble packaging according to the invention are films sold by the company MonoSol LLC under the name M8630, C8400 or M8900, for example. Other suitable films include films with the name Solublon® PT, Solublon® GA, Solublon® KC or Solublon® KL from Aicello Chemical Europe GmbH or the films VF-HP from Kuraray.

The water-soluble packaging can have a substantially dimensionally stable sphere-shaped and cushion-shaped design with a circular, elliptical, quadratic or rectangular basic shape.

The water-soluble packaging can have one or more compartments for storing one or more agents. If the water-soluble packaging has two or more compartments, at least one compartment contains a liquid washing agent. Each of the additional compartments contains a solid or a liquid washing agent.

The invention also relates to a method for cleaning textiles, which method is characterized in that an agent according to the invention is applied in at least one method step, and to the use of a liquid washing agent according to the invention for washing textiles.

These embodiments include both manual and automatic methods, automatic methods being preferred. Methods for cleaning textiles are generally distinguished in that various substances that have a cleaning effect are applied to the item to be cleaned in a plurality of method steps and washed off after the contact time, or in that the item to be cleaned is treated with a washing agent or a solution or dilution of this agent in some other way. All conceivable washing methods can be enhanced in at least one of the method steps by the use of a washing agent according to the invention, and then constitute embodiments of the present invention. All elements, subjects and embodiments that are described for the agent according to the invention can also be applied to this subject of the invention. Therefore, at this juncture, reference is explicitly made to the disclosure at the corresponding point when it was indicated that this disclosure also applies to the above methods and uses according to the invention.

### EXAMPLES

TABLE 1
Washing agent formulation, components in wt. %

| Substance | |
|---|---|
| Linear alkylbenzene sulfonate | 15.0 |
| Fatty alcohol ether sulfate | 5.0 |
| Fatty alcohol-7EO | 8.0 |
| APG | 4.0 |
| Soap | 1.0 |
| DTPMP (phosphonate) | 1.0 |
| Boric acid | 1.0 |
| Citric acid | 3.0 |
| Optical brightener | 0.1 |
| Monoethanolamine | 7.0 |
| SRPs | 2.0 |
| DTI | 1.0 |
| 1,2-propylene glycol | 12.0 |
| Enzymes | 1.5 |
| Water | to 100 |

The formulation was stable after 12 weeks of storage at room temperature. A comparative formulation in which only fatty alcohol-7EO was contained as the non-ionic surfactant proportion demonstrated phase separation after just 2 weeks.

What is claimed is:

1. A liquid washing agent having a surfactant concentration of greater than or equal to 30 wt. % based on the total weight of the agent, and a concentration of polymeric components of greater than or equal to 2 wt. % based on the total weight of the agent characterized in that the agent contains a surfactant system which comprises non-ionic surfactants in an amount of 5 to 20 wt. % based on the total weight of the agent the non-ionic surfactants comprising at least one alkyl ether and at least one alkyl (poly)glycoside, the weight ratio of alkyl ether to alkyl (poly)glycoside being 1:2 to 5:1.

2. The liquid washing agent according to claim 1, characterized in that the agent comprises 5 to 20 wt. % of non-ionic surfactants and the remainder are anionic, cationic, zwitterionic and/or amphoteric surfactants.

3. The liquid washing agent according to claim 1, characterized in that
(1) the at least one alkyl ether is a fatty alcohol alkoxylate;
(2) the at least one alkyl (poly)glycoside is a compound of formula R²O-[G]ₚ, in which R² represents a linear or branched alkyl having 8 to 26 carbon atoms, G represents a sugar residue having 5 or 6 carbon atoms, and p represents numbers from 1 to 10.

4. The liquid washing agent according to claim 1, characterized in that the agent contains, based on the total weight, 5 to 15 wt. % of fatty alcohol alkoxylate and/or 2 to 8 wt. % of alkyl (poly)glycoside.

5. The liquid washing agent according to claim 1, characterized in that the agents contain, in addition to the non-ionic surfactants, at least one anionic surfactant in a total amount of 15 to 25 wt. %, the anionic surfactantsfates in the specified amounts.

6. The liquid washing agent according to claim 1, characterized in that the surfactant system comprises, in each case based in the total weight of the agent:
(1) at least one alkyl ether;
(2) at least one alkyl (poly)glycoside;
(3) at least one alkylbenzene sulfonate; and
(4) at least one alkyl ether sulfate.

7. The liquid washing agent according to claim 1, characterized in that the polymeric components are selected from soil release polymers (SRPs), anti-redeposition agents, dye transfer inhibitors (DTIs) and polymeric dispersing agents.

8. The liquid washing agent according to claim 1, characterized in that the agent contains
(1) at least one enzyme; and/or
(2) additionally at least one additional component selected from the group consisting of builders, bleaching agents, electrolytes, perfumes, perfume carriers, fluorescing agents, dyes, hydrotropic substances, suds suppressors, silicone oils, graying inhibitors, anti-shrink agents, crease protection agents, antimicrobial active ingredients, germicides, fungicides, antioxidants, preservatives, corrosion inhibitors, antistatic agents, bittering agents, ironing aids, repellents and impregnating agents, swelling agents and non-slip agents, softening components, pH adjusters and UV absorbers.

9. A method for cleaning textiles, comprising a step wherein a liquid washing agent according to claim 1 is contacted with textiles in a wash.

10. The liquid washing agent according to claim 1, having a surfactant concentration of ≥30 wt. % based on the total weight of the agent, in the range from 30 to 45 wt. %, and a concentration of polymeric components of ≥2 wt. % based on the total weight of the agent, 2 to 10 wt. %, characterized in that the agent contains a surfactant system which comprises non-ionic surfactants in an amount of 5 to 20 wt. % based on the total weight of the agent, 8 to 15 wt. %, the non-ionic surfactants comprising at least one alkyl ether and at least one alkyl (poly)glycoside, the weight ratio of alkyl ether to alkyl (poly)glycoside being 1:1 to 3:1.

11. The liquid washing agent according to claim 1, having a surfactant concentration of ≥30 wt. % based on the total weight of the agent, in the range from 32 to 38 wt. %, and a concentration of polymeric components of ≥2 wt. % based on the total weight of the agent, 3 to 5 wt. %, characterized in that the agent contains a surfactant system which comprises non-ionic surfactants in an amount of 5 to 20 wt. % based on the total weight of the agent, 8 to 15 wt. %, the non-ionic surfactants comprising at least one alkyl ether and at least one alkyl (poly)glycoside, the weight ratio of alkyl ether to alkyl (poly)glycoside being 1:1 to 3:1.

12. The liquid washing agent according to claim 2, characterized in that the agent comprises 8 to 15 wt. % of non-ionic surfactants and the remainder are anionic surfactants.

13. The liquid washing agent according to claim 3, characterized in that
(1) the at least one alkyl ether is a C₁₀₋₁₈ fatty alcohol ethoxylate having 3-7EO;
(2) the at least one alkyl (poly)glycoside is a compound of formula R²O-[G]ₚ, in which R² represents a linear or branched alkyl having 8 to 20 carbon atoms, G represents glucose, and p represents numbers <8.

14. The liquid washing agent according to claim 3, characterized in that the at least one alkyl (poly)glycoside is a compound of formula R²O-[G]ₚ, in which R² represents a linear or branched alkyl having 8 to 18 carbon atoms, G represents a sugar residue having 5 or 6 carbon atoms, and p represents numbers <6.

15. The liquid washing agent according to claim 3, characterized in that the at least one alkyl (poly)glycoside is a compound of formula R²O-[G]ₚ, in which R² represents a linear or branched alkyl having 8 to 10 carbon atoms, G represents a sugar residue having 5 or 6 carbon atoms, and p represents numbers <4.

16. The liquid washing agent according to claim 3, characterized in that the at least one alkyl (poly)glycoside is a compound of formula R²O-[G]ₚ, in which R² represents a linear or branched alkyl having 12 to 16 carbon atoms, G represents a sugar residue having 5 or 6 carbon atoms, and p represents numbers <2.

17. The liquid washing agent according to claim 3, characterized in that the at least one alkyl (poly)glycoside is a compound of formula R²O-[G]ₚ, in which R² represents a linear or branched alkyl having 8 to 26 carbon atoms, G represents a sugar residue having 5 or 6 carbon atoms, and p represents numbers from 1.4 to 1.8.

18. The liquid washing agent according to claim 4, characterized in that the agent contains, based on the total weight, 6 to 10 wt. % of fatty alcohol alkoxylate and/or 3 to 5 wt. % of alkyl (poly)glycoside.

19. The liquid washing agent according to claim 5, characterized in that the agents contain, in addition to the non-ionic surfactants, at least two anionic surfactants in a total amount of 15 to 25 wt. %, the anionic surfactants being selected from alkylbenzene sulfonates in amounts of 12 to 20 wt. %, of alkyl ether sulfates in amounts of 3 to 8 wt. %, and a combination of alkylbenzene sulfonates and alkyl ether sulfates in the specified amounts

20. The liquid washing agent according to claim 5, characterized in that the agents contain, in addition to the non-ionic surfactants, at least one anionic surfactant being selected from alkylbenzene sulfonates in amounts of 14 to 18 wt. %.
